(19) United States
(12) Patent Application Publication
(10) Pub. No.: US 2015/0269666 A1
(43) Pub. Date: Sep. 24, 2015

(54) DYNAMIC MORTGAGE LOAN PRE-APPROVAL SYSTEM

(71) Applicant: TIMOTHY D. SWIERCZEK, SAINT PAUL, MN (US)

(72) Inventor: TIMOTHY D. SWIERCZEK, SAINT PAUL, MN (US)

(21) Appl. No.: 14/664,807

(22) Filed: Mar. 21, 2015

Related U.S. Application Data
(60) Provisional application No. 61/955,905, filed on Mar. 20, 2014.

(51) Int. Cl. G06Q 40/02

(52) U.S. Cl. CPC G06Q 40/02; G06Q 50/16

(57) ABSTRACT

A system for the provision of dynamic, unique and particularized pre-approval information for the purchase of real estate wherein the information provided is particular for the property in question and limited to buyer's approval.

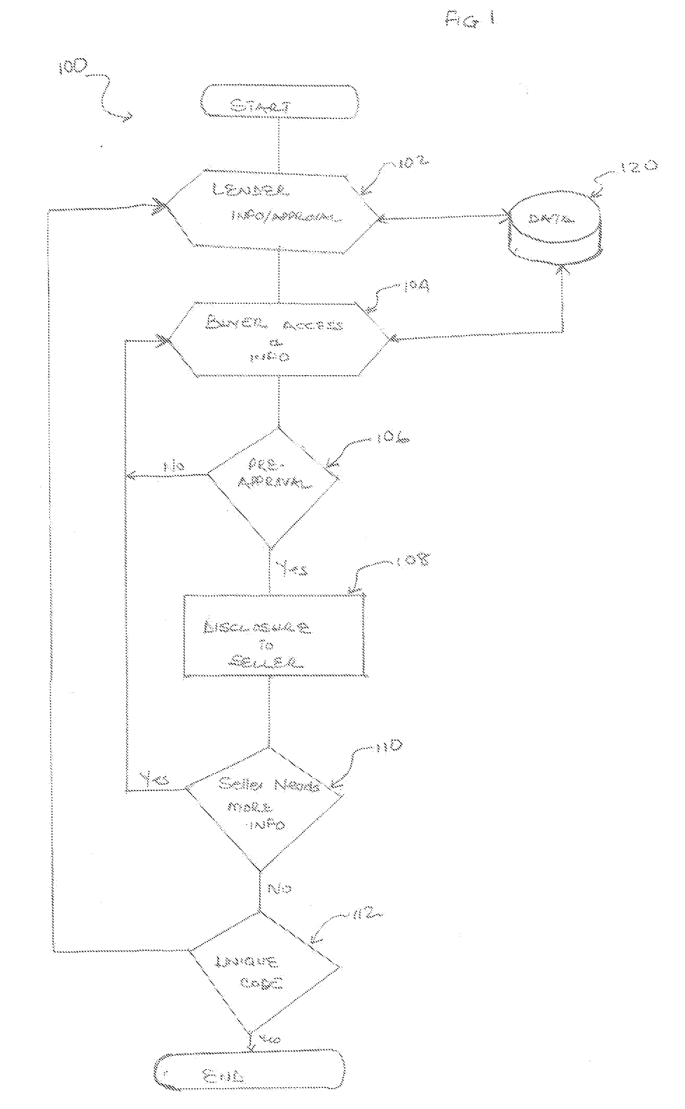

### CROSS REFERENCE

This application claims priority to U.S. Provisional Patent Application No. 61/955,905, filed Mar. 20, 2014, incorporated herein by reference in their entirety.

### BACKGROUND

A prospective purchaser of real estate, such as a new home, is typically concerned about a slew of issues about the new property that she intends to purchase. One of the most pressing concerns for a prospective buyer of real estate is the quality of property that he or she can purchase. The quality could be the size, location, amenities or other properties that matter to the particular purchaser at that moment. Along with the quality of the property to be purchased, the prospective owner has to address her capacity to purchase which is often predicated on whether the she can be approved for a loan to purchase the property. In some instances, the prospective buyer might want to obtain a pre-approval of the loan from her banking institution or financial agency. Sellers and their agents may use this information as an initial document providing insight that the prospective buyer is or may, somehow be able to purchase the property that is for sale.

Since this pre-approval information is typically generalized and not focused on the detail that would subsequently be required by a loan granting institution, it typically is a document without particularity to the property that would be purchased; that is—presented as a shot in time when the prospective buyer approached her financial institution. It does not also express any of the conditions used to obtain such pre-approval and makes no provision about the buyers overall capacity to make the purchase when the actual loan is applied for. Parties to a real estate property purchase need to know that the typically cumbersome process of buying a home is presented with a buyer who is presently capable to follow through with the purchase instead of spending subsequent weeks placing a hold on a transaction that may or may not close. It would be more useful to have a document that is more current or issued with respect to the property being reviewed. A more robust and dynamic process can enhance the buying process and move closing on the purchase deals.

From the above, it is notable that what is needed in the marketplace is a process that provides pertinent and relevant information about a pre-approval obtained by a buyer and transparently offers the seller confidence in the transaction on an instantaneous basis. Such process and product to serve that need are included in this disclosure.

### SUMMARY

In one embodiment, the present invention provides dynamic and current information that a buyer or her agents may preferably utilize to provide assurance to a seller or agent of a capacity to purchase a property at a time of showing.

The present invention provides substantive and dynamic document that can be used to evaluate a purchase with particular reference to the property of interest.

The present invention provides an opportunity for the parties to a real estate transaction to reduce the waiting time between agreement to purchase and closing of a sale.

Another embodiment of the present invention provides a rating system wherein buyers and sellers may preferably utilize to assess readiness and capability in the real estate marketplace.

### BRIEF DESCRIPTION OF THE DRAWING

This invention will be more readily understood from the following detailed description taken in conjunction with the accompanying drawing, in which:

The FIGURE illustrates an embodiment of an activity path supporting a dynamic loan preapproval system.

### DETAILED DESCRIPTION

The FIGURE illustrates an embodiment of an activity path supporting a dynamic loan preapproval system according to the present invention with process diagram 100 wherein prospective purchaser of real estate preferably meets with a financial institution of her choice for a preapproval (or prequalification) for the real estate purchase transaction. At the financial institution or by means available to the institution, pertinent information about the purchaser is obtained 102 and some criterion is provided for the purchaser to engage in the real estate finding process. As is typically the case, most of the generic notice is not sufficient to firm up a real estate purchase transaction. When the notice meets the expected criteria, no further action is required of the purchaser in the real estate transaction for the deal to be concluded. When more information is needed, the financial institution preferably invites a purchaser to utilize the system of the present invention. Such invitation provides the prospective purchaser an opportunity to create account and log-in 104 into the system of the present invention. The purchaser is preferably then offered an opportunity to include more pertinent information usable for the purchase of the real estate of interest. Such information resides in the system 120 of the present invention and is primarily controlled by the purchaser with passwords and identification. Some of the information required of the purchaser may include, but is not limited to, property information and other attendant data to give particularity to the preapproval notice.

The present invention provides an approval notice that is preferably particularized to the buyer and may include the real estate property in question. When the preapproval notice is issued using the system of the present invention, said notice 108 may be provided to a seller with specific information as agreed to by the buyer. At each instance according to the present invention, the buyer has control of the level of disclosure or lack thereof to the seller or seller's agents. If the seller demands more pertinent information 110, the buyer may provide as required or follow through with the logs into the database generating process 104. When the seller is satisfied with the information as provided, a unique code may then be provided for the seller to view other pertinent information 112. If for one reason or another, the information provided is met with a disconnect of any kind, the process of the present invention may be repeated. Similarly, the process can be restarted or managed for use with a new property or process.

The present invention provides a system for a seller and a buyer of real property with real, on-time and dynamic information regarding the pre-approval process for the purchase of such property. The process and product of the present invention avoids the generality of a static and non-particular pre-approval notice and provides a dynamic, on-time, and relevant system that facilitate the purchase process by making such pre-approval notice specific to the seller's property and information. The process for such purchase is thus preferably made transparent, functional and provides control to the parties in the process. Such control by the purchaser includes the level of disclosure or lack thereof. In some instances, a rating system for the pre-approval process may be categorized into a rating or numerical grading system, thus providing more confidence to a seller and buyer that the purchase process can be less cumbersome than is presently usually the case.

According to an embodiment of the present invention, the process is initialized when a potential purchaser of real estate meets or convenes with his or her financial institution for the purpose of obtaining a general pre-approval for the purchase of a real estate property. At the financial institution, relevant information about the preapproval process relative to the prospective buyer is entered into the system of the present invention. Upon completion of this documentation, the lender or financial institution may issue a pre-approved amount to the prospective buyer. The lender or financial institution may then invite the buyer to access the information or use the system of the present invention. The financial institution, according to the present invention may be a bank, mortgage broker or agency, realtor (if and when approved to act for a financial institution, or someone similarly situated to provide such services. The system of the present invention may preferably provide to the potential buyer, a general avatar for use on the system for the purpose of obtaining a specific preapproval notice. It may be useful or necessary for the buyer to formalize and create a unique credential for logging into the system of the present invention.

Upon establishment of a unique identifier or avatar for the purpose of the present invention, the buyer or buyer's agent may log into the system, using the established avatar, the pertinent information about the property in question. After the relevant information about the property in question is entered into the system of the present invention and combined with the information previously entered to obtain a pre-approval from the lender or financial institution, a more particular documentation is then developed for the purchase of the property. The system of the present invention thereafter determines if the potential buyer meets the financial institution's criteria for the purchase of the property. This determination may include the buyer's credit worthiness as obtained from available sources including credit reporting agencies. Other pertinent information may include the status of the real estate title, if clouded or otherwise.

The information collected from the potential buyer may include the purchase price of the property, property taxes, home association dues, and more. This information becomes part of the relevant data or what is used to issue or provide a unique preapproval information or code for the transaction. In some instances, the system of the present invention may determine that the prospective purchaser does not meet the financial institution's criteria for a unique preapproval note or code to be provided. If the pre-approval notice is not available for any reason, the system will not issue a notice; the financial institution and prospective buyer may convene to address the reason(s) for such non-issuance and discuss or address the next steps to resolve reasons for said non-issuance. Other options include the potential buyer revisiting the system of the present invention to include more pertinent information about the buyer, property or both to clarify aspects of disconnect for better information to achieve a desired conclusion.

The system of the present invention may then utilize the information provided to generate the unique pre-approval notice of the present invention. It is reasonable to note that the unique pre-approval notice of the present invention is preferably based on the personal and particular information provided by the prospective buyer. An advantage of the present system is the provision of choice to the buyer as to the information that he or she would want the potential seller or their agent privy to. The buyer, using the system of the present invention may limit the disclosure to only the information that he or she is comfortable with. As an example, a buyer may opt to release any and all available information to the seller. Another buyer may elect to provide only information related to debt-to-income ratio, money down, results of automated underwriting, credit score or combinations thereof. Yet again, another potential buyer may choose to not release any information to the seller. In each instance, a dynamic pre-approval notice according to the system of the present invention would generate a unique pre-approval note or code that reflects the demand and interests of the purchaser while giving confidence and comfort to the seller that the purchaser has capacity to further the deal.

A seller utilizing the pre-approval note or code of the present invention may be particular as such preapproval notice would be specifically for the purchase of the home in question and not a generalized document which may or may not reference the transaction in question as most pre-approval notices are about the buyer without regard to the seller's property. These confidence and comfort eliminate the general impression that pre-approval notices are too generic to provide encouragement or specificity to the parties in the transaction.

Another advantage of the preapproval notice of the present invention is the additional negotiating power that it provides the buyer in the transaction. As an example, when the seller has confidence that he or she is just not going through the back-and-forth process with a buyer who, for one reason or another, may not be seen as having capacity, the seller is more likely than not, reticent to give concessions to close a deal. In this instance, using the pre-approval of the present invention, the buyer can be firmer in his or her demand for concessions and the seller may be more encouraged to give in to close the deal. In any case, if the buyer cannot extract concessions, the conclusions can likely be made that the seller is firm at said offer price. Both parties can arrive at an agreement more expeditiously than with a generic pre-approval notice or absence of one.

The availability of the pre-approval notice according to the present invention provides transparency to the process as each party may have access provided to review pertinent and disclosed information about the transaction. It is reasonable to expect a code that may be accessed via computer, portable data devices, or telephone to each party, taking into account the necessary security measures to prevent unintended release of information. Each party using the system of the present invention may be provided with a code, credential, avatar or other unique identifiable information for access of information that each party deems or is comfortable with releasing for the transaction.

The system of the present invention may develop a coding system to provide a rating system usable in the real estate community for the evaluation of buyers of real estate properties. Such system and rating may be coded to eliminate the need to provide extraneous information to the seller, that all that would be needed may be the code or rated number, wherein such would provide confidence or lack thereof for the transaction. In all instances, the buyer in the transaction controls the information released to any party in the purchase.

The present invention may be particularized as a banking system specifically focused on the real estate market and the process for obtaining preapproval for the sale and purchase of real estate.

Having thus described the preferred embodiments of the present invention, those of skill in the art will readily appreciate that the teachings found herein may be applied to yet other embodiments.

What is claimed is:

1. A real estate transaction system, comprising
establishing a loan preapproval method, said method including;
setting up a record;
wherein said record includes information regarding a property for sale and a buyer of said property;
a buyer accessing said information and incorporating personal information to further the sale transaction;
said information usable to confer a preapproval notice for the buyer;
wherein said preapproval notice provides a unique code to facilitate the real estate transaction.

2. The system of claim 1, wherein the establishing the loan approval method includes creating a data file by a financial institution.

3. The system of claim 2, wherein the financial institution includes bank, mortgage company, realtor, agent or broker.

4. The system of claim 1, wherein the record includes information obtained from sources other than buyer and seller.

5. The system of claim 4, wherein the record includes credit report or credit worthiness of buyer.

6. The system of claim 4, wherein the record includes real estate title status.

7. The system of claim 1, wherein the buyer is not issued a preapproval notice.

8. The system of claim 1, wherein the buyer is provided an opportunity to provide further information usable to obtain preapproval after denial.

9. A banking system, comprising
establishing a real estate loan transaction preapproval method, said method including;
setting up a record;
wherein said record includes information regarding a property for sale and a buyer of said property;
a buyer accessing said information and incorporating personal information to further the sale transaction;
said information usable to confer a preapproval notice for the buyer;
wherein said preapproval notice provides a unique code to facilitate the real estate transaction.

10. The system of claim 9, wherein the establishing the loan approval method includes creating a data file by a mortgage broker.

11. The system of claim 10, wherein the broker includes, mortgage company, realtor, or agent.

12. The system of claim 9, wherein the record includes information obtained from sources other than buyer and seller.

13. The system of claim 12, wherein the record includes credit report or credit worthiness of buyer.

14. The system of claim 12, wherein the record includes real estate title status.

15. The system of claim 9, wherein the buyer is not issued a preapproval notice.

16. The system of claim 9, wherein the buyer is provided an opportunity to provide further information usable to obtain preapproval after denial.
